(19) United States
(12) Patent Application Publication
(10) Pub. No.: US 2026/0152170 A1
(43) Pub. Date: Jun. 4, 2026

(54) HYBRID VEHICLE AND A METHOD OF CONTROLLING TORQUE FLUCTUATIONS THEREOF

(71) Applicants: HYUNDAI MOTOR COMPANY, Seoul (KR); KIA CORPORATION, Seoul (KR)

(72) Inventors: Key Chun Park, Hwaseong-si (KR); Tae Hyun Lee, Hwaseong-si (KR)

(73) Assignees: HYUNDAI MOTOR COMPANY, Seoul (KR); KIA CORPORATION, Seoul (KR)

(21) Appl. No.: 19/226,905

(22) Filed: Jun. 3, 2025

(30) Foreign Application Priority Data
Nov. 29, 2024 (KR) 10-2024-0175324

(51) Int. Cl. B60W 20/15; B60W 10/06; B60W 10/08; B60W 30/20

(52) U.S. Cl. CPC B60W 20/15; B60W 10/06; B60W 10/08; B60W 30/20; B60W 2030/206; B60W 2510/0638; B60W 2510/0657; B60W 2510/0685; B60W 2510/088; B60W 2710/083

(57) ABSTRACT

A hybrid vehicle and a method for controlling torque fluctuations. The hybrid vehicle includes a controller configured to determine engine torque fluctuations in a transient state in which an operating point of the engine changes based on an inertial torque generated by rotational inertia during the operation of the engine and a pressure torque caused by pressure generated during combustion of fuel in the engine. The controller is configured to apply a counter torque command to the motor to offset the engine torque fluctuations.

### CROSS-REFERENCE TO THE RELATED APPLICATION

This application claims priority to Korean Patent Application No. 10-2024-0175324, filed on Nov. 29, 2024 in the Korean Intellectual Property Office, the disclosure of which is incorporated herein by reference in its entirety.

### BACKGROUND

### 1. Field

The present disclosure relates to a hybrid vehicle and a method of controlling torque fluctuations to reduce engine torque fluctuations.

### 2. Description of the Related Art

A powertrain of a hybrid vehicle is equipped with an internal combustion engine and a motor connected to a rotating shaft of the internal combustion engine. In relation to the powertrain of such a hybrid vehicle, there are technologies for controlling the opposite phase of engine torque using a motor.

For opposite phase control for engine torque, technology for predicting fluctuations in engine torque is important, and in order to predict fluctuations in engine torque, many engine control variables (e.g., valve timing, intake pressure, ignition timing, air-fuel ratio, fuel amount, etc.) are considered at various operating points of the engine.

The matters described as background technology above are only intended to enhance understanding of the background of the present disclosure and should not be taken as an acknowledgment that they correspond to prior art already known to those having ordinary skill in the art.

### SUMMARY

The present disclosure provides a hybrid vehicle capable of reducing engine torque fluctuations through motor control in a transient state in which the operating point of the engine changes rapidly, and a method of controlling torque fluctuations thereof.

Embodiments of the present disclosure are not limited to the aspects mentioned above, and other aspects not mentioned should be clearly understood by those having ordinary skill in the art from the description below.

In an aspect of the present disclosure, a hybrid vehicle includes: an engine, a motor directly connected to the engine and configured to rotate together with the engine, and a controller configured to determine engine torque fluctuations in a transient state in which an operating point of the engine changes based on an inertial torque generated by rotational inertia during an operation of the engine and a pressure torque caused by pressure generated during fuel combustion in the engine. and the controller is configured to apply a counter torque command to the motor to offset the engine torque fluctuations.

In accordance with another aspect of the present disclosure, there is provided a method of controlling torque fluctuations of a hybrid vehicle having an engine and a motor directly connected to and rotating together with the engine. The method includes: determining engine torque fluctuations in a transient state in which an operating point of the engine changes based on an inertial torque generated by rotational inertia during an operation of the engine and a pressure torque caused by pressure generated during combustion of fuel in the engine, and applying a counter torque command to the motor to offset the engine torque fluctuations.

### BRIEF DESCRIPTION OF THE DRAWINGS

The above and other objects, features and other advantages of the present disclosure should be more clearly understood from the following detailed description taken in conjunction with the accompanying drawings, in which:

FIG. 1 is a diagram illustrating a configuration of a hybrid vehicle according to an embodiment of the present disclosure;

FIG. 2 is a diagram illustrating a controller of the hybrid vehicle according to an embodiment of the present disclosure;

FIG. 3 is a diagram showing a combustion torque profile according to an embodiment of the present disclosure;

FIG. 4 is a diagram illustrating a first configuration of the hybrid vehicle according to an embodiment of the present disclosure;

FIG. 5 is a diagram illustrating a second configuration of the hybrid vehicle according to an embodiment of the present disclosure;

FIG. 6 is a diagram illustrating a third configuration of the hybrid vehicle according to an embodiment of the present disclosure;

FIG. 7 is a flowchart illustrating a method of controlling torque fluctuations of the hybrid vehicle according to an embodiment of the present disclosure; and

FIG. 8 is a flowchart illustrating a combustion pressure torque determination process according to an embodiment of the present disclosure.

The statements in this section merely provide background information related to the present disclosure and may not constitute prior art.

### DETAILED DESCRIPTION

Specific structural and functional descriptions of the embodiments of the present disclosure, disclosed in the present specification or application, are merely illustrative for the purpose of explaining the embodiments according to the present disclosure, and the embodiments according to the present disclosure may be implemented in various forms and should not be construed as being limited to the embodiments described in this specification or application.

Since the embodiments according to the present disclosure may be modified in various manners and implemented in various forms, specific embodiments are illustrated in the drawings and described in detail in the specification or application. However, this is not intended to limit the embodiments, according to the concept of the present disclosure, to the specific forms disclosed, and should be understood to include all modifications, equivalents, and substitutes that fall within the spirit and technical scope of the present disclosure.

All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification are described in detail with reference to the attached drawings. However, identical or similar components are assigned the same reference numeral, and redundant descriptions thereof have been omitted.

In the description of the following embodiments, the term “preset” means that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit” or “part,” as used herein to denote components, are intended to aid in understanding the disclosed embodiments and are not intended to impart any specific structural meaning or role unless otherwise specified. The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

In the following description of the embodiments disclosed in the present specification, a detailed description of known functions and configurations incorporated herein have been omitted when it may obscure the subject matter of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it should be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, a unit or a control unit included in names such as a motor control unit (MCU) and a hybrid control unit (HCU) is merely a term widely used in naming a control device that controls specific vehicle functions and does not mean a generic functional unit.

A controller may include: a communication device that communicates with other controllers or sensors to control the functions of the controller, a memory that stores an operating system, logic instructions, input/output information, etc., and one or more processors that perform determination, computation, and decisions necessary to control the functions.

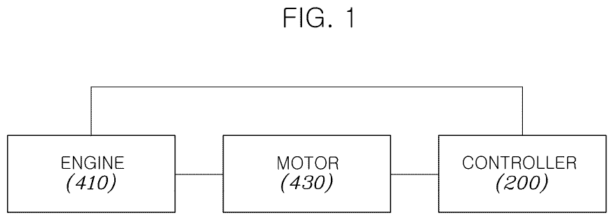

Prior to introducing a method of controlling torque fluctuation of a hybrid vehicle according to an embodiment of the present disclosure, the configuration and control logic of a hybrid vehicle according to an embodiment are described below with reference to FIG. 1 to FIG. 3.

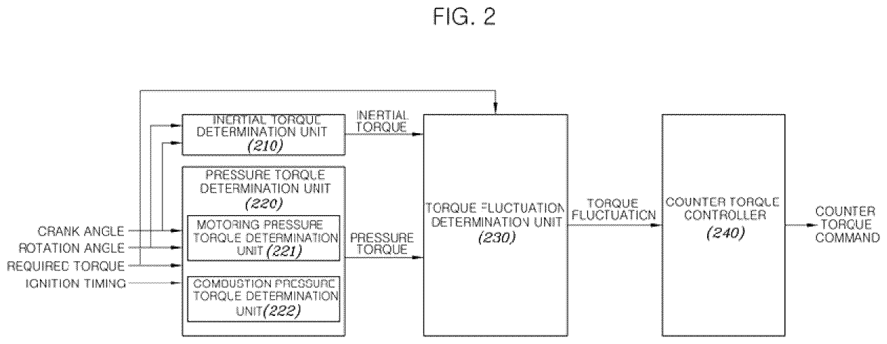

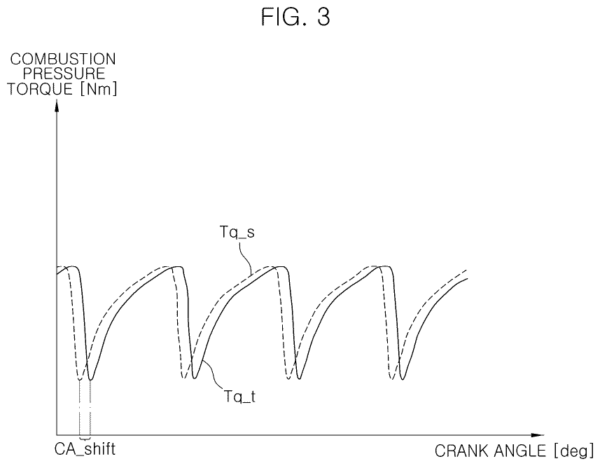

FIG. 1 is a diagram showing a configuration of a hybrid vehicle according to an embodiment of the present disclosure, FIG. 2 is a diagram illustrating a controller of the hybrid vehicle according to an embodiment of the present disclosure, and FIG. 3 is a diagram showing a combustion torque profile according to an embodiment of the present disclosure.

According to an embodiment of the present disclosure, referring to FIG. 1, the hybrid vehicle may include: an engine 410, a motor 430, and a controller 200. However, FIG. 1 mainly shows components related to the description of an embodiment, and a real hybrid vehicle may include more components.

In an embodiment, the engine 410 and the motor 430 are directly connected to each other and may constantly rotate together. In such a connection structure of the engine 410 and the motor 430, the controller 200 can offset torque fluctuations in the engine 410 by controlling the torque of the motor 430. In other words, the controller 200 is configured to compensate for torque fluctuations in the engine 410 by adjusting the torque of the motor 430.

To this end, the controller 200 may predict engine torque fluctuations and apply a counter torque command to the motor 430 to offset the predicted engine torque fluctuations, thereby reducing engine torque fluctuations. Here, engine torque fluctuation refers to a torque component that causes vibration of the engine and may be represented as an engine roll vibration torque (or engine roll vibration torque component).

In this operation, the controller 200 according to an embodiment may predict engine torque fluctuations using only a few control variables, such as the rotation speed of the engine 410, a required torque, a crank angle, and ignition timing, instead of utilizing a large number of various engine control variables. For example, the controller 200 may obtain engine control variables as described above from an engine control unit that controls the engine 410 through in-vehicle communication such as CAN communication. Through this, constraints on acquisition of control variables and computational load of the controller 200 can be alleviated, and the degree of freedom in implementing the controller 200 can also be increased.

According to an embodiment, the controller 200 may apply the counter torque command to the motor 430 through a motor control unit that controls the motor 430 instead of directly applying the counter torque command to the motor 430. In other words, the controller 200 may obtain engine control variables from the engine control unit and control the motor control unit based on the obtained engine control variables. According to an embodiment, the controller 200 may be implemented as a hybrid controller that functions as an upper-level controller configured to control lower-controllers such as the engine control unit and the motor control unit.

In an embodiment, torque fluctuations in the engine 410 can be controlled using only a minimum set of engine control variables, rather than using all of numerous and various engine control variables. As a result, constraints related to acquisition of control variables or computational load can be alleviated when implementing the controller 200 as an upper-level controller, such as a hybrid controller.

More specifically, referring to FIG. 2, the controller 200 may include an inertial torque determination unit 210, a pressure torque determination unit 220, a torque fluctuation determination unit 230, and a counter torque controller 240, and the controller 200 may obtain the rotation speed, required torque, crank angle, and ignition timing of the engine 410 as input values and may output a counter torque command. However, FIG. 2 merely shows an embodiment of the controller 200, and implementation of the controller 200 is not necessarily limited thereto.

In an embodiment, the inertial torque determination unit 210 may determine an inertial torque based on the rotation speed of the engine 410. Here, the inertial torque refers to a torque component generated by rotational inertia during operation of the engine 410. More specifically, the inertial torque may refer to a torque generated at the crank shaft via the connecting rod while the reciprocating mass of the engine (e.g., piston pack and effective big end of the connecting rod) moves in a reciprocating manner during the engine 410 rotation.

The inertial torque determination unit 210 may determine the inertial torque based on the square of the acquired engine rotation speed. For example, the inertial torque determination unit 210 may analyze the inertial torque depending on the engine rotation speed through engine dynamometer tests and determine the inertial torque with reference to a preset inertial torque look-up table (LUT). In this case, the inertial torque look-up table may be set to store a value obtained by dividing the inertial torque value for each engine rotation speed obtained through engine dynamometer tests by the square of the rotation speed, and then output a value multiplied by the square of the input value when the rotation speed of the engine 410 is input in real time.

The pressure torque determination unit 220 may determine a pressure torque based on the rotation speed and required torque among engine control variables. The required torque may refer to an amount of torque that the engine needs to generate at a given moment to meet the vehicle's operational demands (e.g., the driver's acceleration request). The pressure torque may include a motoring pressure torque component and a combustion pressure torque component. According to an embodiment, the pressure torque determination unit 220 may determine a motoring pressure torque and a combustion pressure torque separately through a motoring pressure torque determination unit 221 and a combustion pressure torque determination unit 222.

Here, the pressure torque may refer to the sum of torques generated by the pressure produced during fuel combustion in the engine 410. The motoring pressure torque may refer to a crank torque generated by inflow and outflow of air during combustion of the fuel, and the combustion pressure torque may refer to a torque generated by the pressure component attributable solely to fuel combustion, excluding the motoring pressure from the total pressure generated during fuel combustion in the engine of the power system. The inertial torque and the motoring pressure torque have a mean torque of 0, whereas the combustion pressure torque has a mean torque component in addition to a torque fluctuation component.

The motoring pressure torque determination unit 221 may determine the motoring pressure torque based on the rotation speed and the required torque of the engine 410. To this end, the motoring pressure torque determination unit 221 may analyze the motoring pressure torque according to the rotation speed and required torque of the engine through engine dynamometer tests and refer to the preset motoring pressure torque look-up table.

According to the embodiment, the motoring pressure torque determination unit 221 may determine the motoring pressure torque by reflecting both the motoring pressure torque when the throttle valve is closed and the motoring pressure torque when the throttle valve is fully opened.

The state in which the throttle valve is closed may be referred to as an idle state or a minimum throttle opening state, while the state in which the throttle valve is fully opened may be referred to as a Wide Open Throttle (WOT) state.

For example, the motoring pressure torque determination unit 221 may determine the motoring pressure torque by referring to a motoring pressure torque look-up table set by summing the motoring pressure torque values analyzed based on the rotation speed and the required torque of the engine 410 in the state in which the throttle valve is closed and the motoring pressure torque analyzed depending on the rotation speed and the required torque of the engine 410 in the state in which the throttle valve is fully open. In other words, the motoring pressure torque determination unit 221 may determine the motoring pressure torque by referring to the motoring pressure torque look-up table configured by summing the motoring pressure torque values analyzed based on the engine rotation speed and required torque in both the throttle-closed state and the fully open throttle state of the engine 410.

As another example, the motoring pressure torque determination unit 221 may determine the motoring pressure torque by referring to an idle motoring pressure torque look-up table in which the motoring pressure torque analyzed depending on the rotation speed and the required torque of the engine 410 in the state in which the throttle valve is closed is preset, and a Wide Open Throttle (WOT) motoring pressure torque look-up table in which the motoring pressure torque depending on the rotation speed and the required torque of the engine 410 in the state in which the throttle valve is fully open is preset.

More specifically, the controller 200 may extract the motoring pressure torque corresponding to the current rotation speed and required torque of the engine 410 from the idle motoring pressure torque look-up table and the WOT motoring pressure torque look-up table, and determine the motoring pressure torque by summing the two extracted motoring pressure torques.

The combustion pressure torque determination unit 222 determines the combustion pressure torque based on a preset Wide Open Throttle (WOT) combustion pressure torque profile and the required torque and the rotation speed of the engine 410. A pressure torque profile generally refers to a graph or dataset that shows how a combustion pressure-derived torque varies over a crank angle and/or across different engine speeds and loads.

Here, the WOT combustion pressure torque profile may refer to a combustion pressure torque value for each crank angle of the engine 410 in the state in which the throttle valve of the engine 410 is fully open and may be obtained through engine dynamometer tests in the fully open state of the throttle valve. The WOT combustion pressure torque profile may be stored in the combustion pressure torque determination unit 222 in the form of, for example, a look-up table.

More specifically, the combustion pressure torque determination unit 222 may determine or generate a steady-state combustion pressure torque profile based on the WOT combustion pressure torque profile, and the required torque and the rotation speed of the engine 410. In this case, the steady-state combustion pressure torque profile may be obtained by multiplying the value at each operating point (defined by rotation speed and required torque) on the WOT combustion pressure torque profile by the value obtained by dividing the required torque of the engine 410 by the maximum torque that can be output at each operating point.

Meanwhile, in the hybrid vehicle according to an embodiment, the combustion pressure torque determination unit 222 may determine the combustion pressure torque by further reflecting the ignition timing of the engine 410 in order to improve the accuracy of determining engine torque fluctuations in the transient state.

Here, the transient state of the engine 410 refers to a state in which the rotation speed or the required torque of the engine 410 suddenly changes and the operating point changes rapidly. This transient state is in contrast to the normal state in which the engine 410 maintains a constant operating point and operates stably. For example, the transient state may be defined as a state in which the amount of operating point change or fluctuation rate of the engine 410 exceeds a preset threshold.

Since the engine control variables change rapidly in such a transient state, it may be more difficult to predict engine torque fluctuations in real time. Therefore, in an embodiment, a method of predicting engine torque fluctuations in the transient state using the ignition timing of the engine 410 in a simple manner that does not require many control variables is provided.

More specifically, the combustion pressure torque determination unit 222 may determine the combustion pressure torque based on a transient combustion pressure torque profile, which is obtained by compensating the steady-state combustion pressure torque profile based on the crank angle shift amount depending on the ignition timing of the engine 410.

Since the steady-state combustion pressure torque profile is based on the steady-state of the engine 410, the steady-state combustion pressure torque profile is compensated through the crank angle shift amount in order to obtain the combustion pressure torque in the transient state. Accordingly, it is possible to predict engine torque fluctuations by taking into account the combustion pressure torque in the transient state.

Here, the crank angle shift amount is a value based on the difference in ignition timing between the transient state and the steady state, and may be defined as a crank angle between a maximum torque generation point in the steady state and a maximum torque generation point in the transient state.

The crank angle shift amount may be determined based on a first crank lag angle and a second crank lag angle. A crank lag angle refers to a rotational angle of the crankshaft that represents a delay or phase difference between key events in the engine's combustion cycle. The first crank lag angle may refer to an angle from the ignition timing of the engine 410 to the maximum pressure generation point of the engine 410, and the second crank lag angle may refer to an angle from the maximum pressure generation point of the engine 410 to the maximum torque generation point of the engine 410.

In this case, the first crank lag angle may be determined on the basis of the real-time ignition timing, the required torque, and the rotation speed of the engine 410. The second crank lag angle may be determined on the basis of the real-time required torque and rotation speed of the engine 410.

The combustion pressure torque determination unit 222 may determine a total lag angle from the ignition timing to the maximum torque generation point using the sum of the first crank lag angle and the second crank lag angle.

The combustion pressure torque determination unit 222 may determine a final crank angle shift amount by subtracting the ignition timing in the WOT state from the total lag angle, and may obtain a transient combustion pressure torque profile by compensating the steady-state combustion pressure profile on the basis of the crank angle shift amount.

In this case, the ignition timing in the WOT state may be determined based on the rotation speed of the engine 410, and for example, among ignition timing values set for respective rotation speeds of the engine 410, the value according to the current rotation speed of the engine 410 may be subtracted from the total lag angle.

Since the steady-state combustion pressure profile is based on the WOT state of the throttle valve, a transient combustion pressure torque profile indicating the combustion pressure torque depending on the crank angle in the transient state can be obtained by applying the crank angle shift amount obtained by subtracting the ignition timing in the WOT state from the total lag angle.

Compensation based on the crank angle shift amount may mean, for example, shifting the value of the combustion pressure torque for each crank angle by the crank angle shift amount “CA_shift” in the steady-state combustion pressure torque profile “Tq_s” as shown in FIG. 3.

In an embodiment, the pressure torque determination unit 220 may determine the pressure torque by summing the motoring pressure torque and the combustion pressure torque determined by the motoring pressure torque determination unit 221 and the combustion pressure torque determination unit 222.

The torque fluctuation determination unit 230 may determine the value of engine torque fluctuation by subtracting the required torque of the engine 410 from the total torque obtained by summing the values of the determined inertial torque and pressure torque.

The counter torque controller 240 generates a counter torque command to offset torque fluctuations based on the determined torque fluctuation, and for example, the counter torque command may have a value corresponding to the magnitude of the predicted engine torque fluctuation and having an opposite phase.

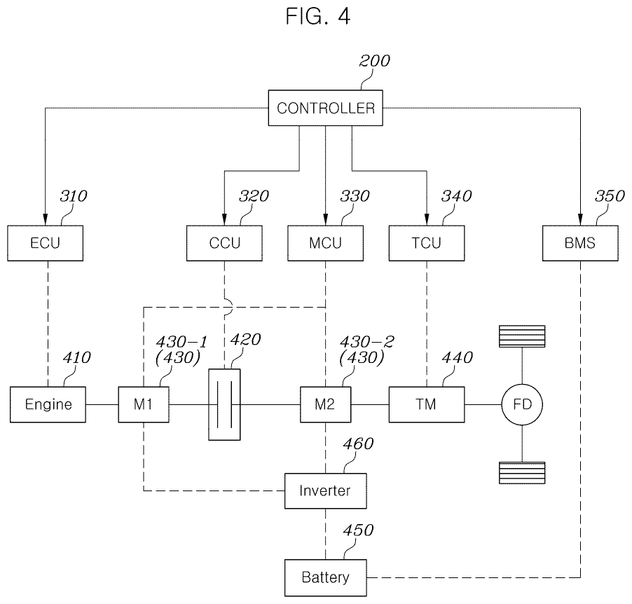

Hereinafter, various implementation examples of the hybrid vehicles are described with reference to FIG. 4 to FIG. 6.

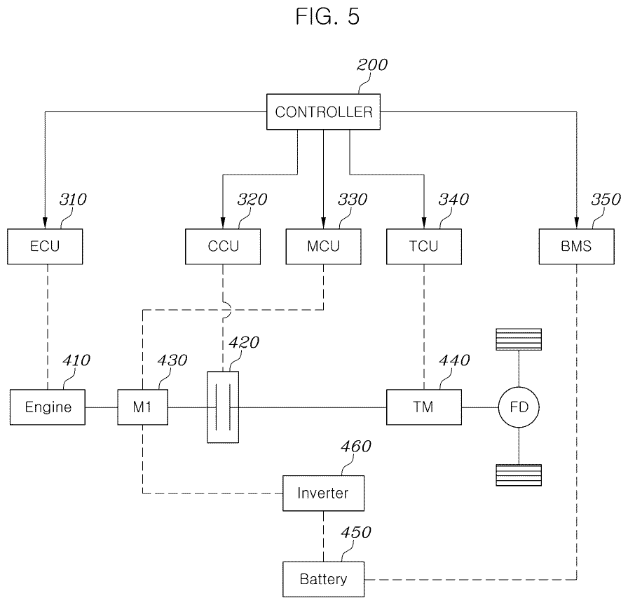

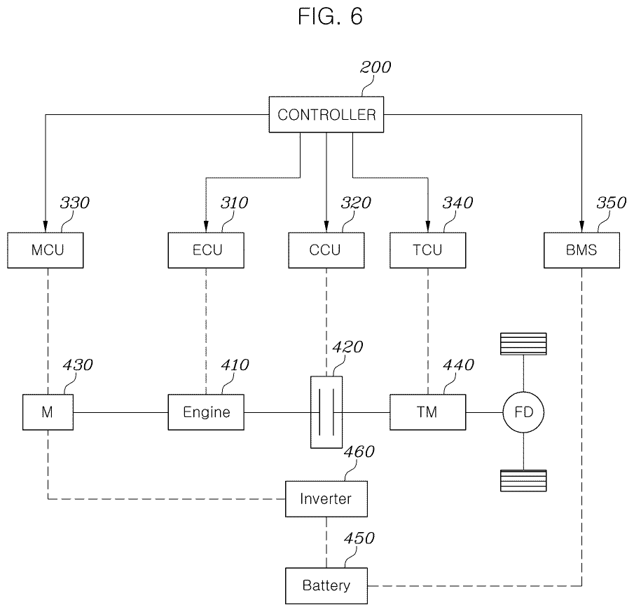

FIG. 4 is a diagram illustrating a first configuration of the hybrid vehicle according to an embodiment, FIG. 5 is a diagram illustrating a second configuration of the hybrid vehicle according to an embodiment of the present disclosure, and FIG. 6 is a diagram illustrating a third configuration of the hybrid vehicle according to an embodiment of the present disclosure.

First, referring to FIG. 4 to FIG. 6, the controller 200 may be implemented as an upper-level controller that controls lower-level controllers including an engine control unit (ECU) 310, a clutch control unit (CCU) 320, a motor control unit (MCU) 330, a transmission control unit (TCU) 340, and a battery management system (BMS) 350.

The engine control unit 310 may control the engine 410 in response to control of the upper-level controller 200, and the clutch control unit 320 may control a clutch 420 in response to control of the upper-level controller 200.

The motor control unit 330 may control the motor 430 in response to control of the upper-level controller 200, and the transmission control unit 340 may control a transmission 440 in response to control of the upper-level controller 200.

The BMS 350 may control a battery 450 in response to control of the upper-level controller 200, and an inverter 460 may supply power supplied from the battery 450 to the motor 430.

The hybrid vehicle may have a powertrain including the engine 410, the clutch 420, at least one motor 430, the transmission 440, the battery 450, and the inverter 460. The configuration of the powertrain may be modified in various manners.

Referring to FIG. 4, the powertrain of the hybrid vehicle according to the first configuration may include a first motor 430-1 and a second motor 430-2. In this case, the first motor 430-1 and the engine 410 may be directly connected to each other and may constantly rotate together. One end of the clutch 420 is coupled to the first motor 430-1, and the second motor 430-2 may be connected between the other end of the clutch 420 and the transmission 440.

Referring to FIG. 5, the powertrain of the hybrid vehicle according to the second configuration may not include a motor provided between the clutch 420 and the transmission 440, unlike the first configuration illustrated in FIG. 4. However, as in FIG. 4, the motor 430 is directly connected to the engine 410 and constantly rotates together with the engine 410, and the motor 430 may be coupled to one end of the clutch 420.

Referring to FIG. 6, the powertrain of the hybrid vehicle according to the third configuration may be provided with the engine 410 between the motor 430 and one end of the clutch 420, instead of the motor 430 being connected between the engine 410 and one end of the clutch 420.

In addition, the powertrain of the hybrid vehicle may be implemented in various manners on the premise that at least one motor 430 is directly connected to the engine 410 and rotates together.

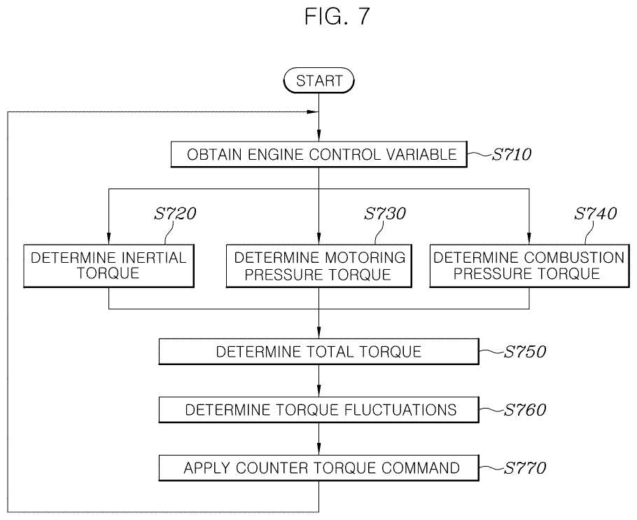

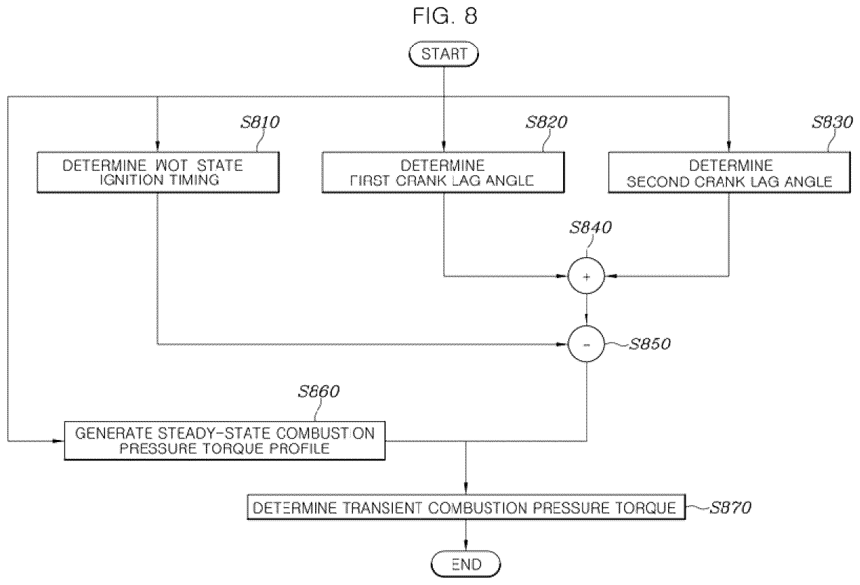

Hereinafter, a method of controlling torque fluctuation of a hybrid vehicle according to an embodiment is described with reference to FIG. 7 and FIG. 8.

FIG. 7 is a flowchart illustrating a method of controlling torque fluctuation of the hybrid vehicle according to an embodiment of the present disclosure.

Referring to FIG. 7, the controller 200 may obtain engine control variables (S710). In this case, the engine control variables may be provided from the engine control unit, and the controller 200 may obtain the engine control variables through in-vehicle communication such as CAN communication. The obtained engine control variables may include, for example, the rotation speed of the engine 410, the crank angle, the required torque, the ignition timing, and the like and may also include a combustion state (combustion or non-combustion).

The controller 200 may determine an inertial torque, a motoring pressure torque, and a combustion pressure torque on the basis of the obtained engine control variables (in respective operations S720, S730, and S740), and the controller 200 may determine the total torque of the engine 410 by summing the values of the determined inertial torque, motoring pressure torque, and combustion pressure torque (in an operation S750).

The controller 200 may determine a value of engine torque fluctuation by subtracting the required torque of the engine 410 from the total torque of the engine 410 (in an operation S760), generate a counter torque command to offset the engine torque fluctuation on the basis of the determined value, and apply the generated counter torque command to the motor or the motor control unit that controls the motor (in an operation S770).

The process of determining the combustion pressure torque (operation S740) is described in more detail below with reference to FIG. 8.

FIG. 8 is a flowchart illustrating the combustion pressure torque determination process according to an embodiment of the present disclosure.

Referring to FIG. 8, the operation S740 of determining the combustion pressure torque is illustrated in more detail.

The operation S740 of determining the combustion pressure torque may include: determining an ignition timing in a throttle valve WOT state (an operation S810), determining a first crank lag angle (an operation S820), and determining a second crank lag angle (an operation S830).

The controller 200 may determine a total lag angle by summing the first crank lag angle and the second crank lag angle (in operation S840), and may determine a crank angle shift amount by deducting the ignition timing in the WOT state from the total lag angle (in operation S850).

Further, the controller 200 may generate a steady-state combustion pressure torque profile based on a combustion pressure torque profile in the WOT state (in an operation S860). In an operation S870, the controller 200 may determine a combustion pressure torque using a transient combustion pressure torque profile, which is obtained by compensating the steady-state combustion pressure torque profile based on the crank angle shift amount.

According to various embodiments of the present disclosure as described above, it is possible to improve the accuracy of prediction of engine torque fluctuations in a transient state while reducing the burden of acquisition and computation of engine control variables, and to offset engine torque fluctuations by controlling the motor using the predicted torque fluctuations.

The effects that can be obtained from the present disclosure are not limited to the effects mentioned above, and other effects that are not mentioned should be clearly understood by those having ordinary skill in the art to which the present disclosure belongs from the description below.

Although the present disclosure has been illustrated and described with respect to specific embodiments as described above, it should be apparent to those having ordinary skill in the art that the present disclosure can be modified and changed in various manners without departing from the technical idea of the present disclosure provided by the following claims

What is claimed is:

1. A hybrid vehicle including:
an engine;
a motor directly connected to the engine and configured to rotate together with the engine; and
a controller configured to:
determine engine torque fluctuations in a transient state in which an operating point of the engine changes based on an inertial torque generated by rotational inertia during an operation of the engine and a pressure torque caused by pressure generated during fuel combustion in the engine, and
apply a counter torque command to the motor to offset the engine torque fluctuations.

2. The hybrid vehicle of claim 1, wherein the controller is configured to determine the pressure torque based on a motoring pressure torque generated by pressure caused by inflow and outflow of air during the fuel combustion and a combustion pressure torque generated by pressure caused by the fuel combustion in the engine.

3. The hybrid vehicle of claim 2, wherein the controller is configured to determine the combustion pressure torque based on a required torque of the engine, a rotation speed of the engine, and a Wide Open Throttle(WOT) combustion pressure torque profile in which a combustion pressure torque at each crank angle of the engine in a state in which a throttle valve of the engine is fully open is preset.

4. The hybrid vehicle of claim 3, wherein the controller is configured to determine the combustion pressure torque based on the WOT combustion pressure torque profile, and a transient combustion pressure torque profile obtained by compensating a steady-state combustion pressure torque profile, determined based on the required torque and the rotation speed of the engine, based on a crank angle shift amount depending on ignition timing of the engine.

5. The hybrid vehicle of claim 4, wherein the crank angle shift amount is determined based on a first crank lag angle from the ignition timing of the engine to a maximum pressure generation point of the engine and a second crank lag angle from the maximum pressure generation point of the engine to a maximum torque generation point of the engine.

6. The hybrid vehicle of claim 5, wherein the first crank lag angle is determined based on the ignition timing, the rotation speed, and the required torque of the engine.

7. The hybrid vehicle of claim 5, wherein the second crank lag angle is determined based on the rotation speed and the required torque of the engine.

8. The hybrid vehicle of claim 5, wherein the crank angle shift amount is determined based on a value obtained by subtracting a value corresponding to the rotation speed of the engine among ignition timings in a preset Wide Open Throttle (WOT) state in which a throttle valve of the engine is fully open from a sum of the first crank lag angle and the second crank lag angle.

9. The hybrid vehicle of claim 2, wherein the controller is configured to determine the motoring pressure torque based on a rotation speed and a required torque of the engine.

10. The hybrid vehicle of claim 1, wherein the controller is configured to determine the engine torque fluctuations based on a value obtained by subtracting a required torque of the engine from a sum of the inertial torque and the pressure torque.

11. A method of controlling torque fluctuations of a hybrid vehicle including an engine and a motor directly connected to and rotating with the engine, the method comprising:
determining engine torque fluctuations in a transient state in which an operating point of the engine changes based on an inertial torque generated by rotational inertia during an operation of the engine and a pressure torque caused by pressure generated during fuel combustion in the engine; and
applying a counter torque command to the motor to offset the engine torque fluctuations.

12. The method of claim 11, wherein determining engine torque fluctuations comprises:
determining the pressure torque based on a motoring pressure torque generated by pressure caused by inflow and outflow of air during the fuel combustion and a combustion pressure torque generated by pressure caused by the fuel combustion in the engine.

13. The method of claim 12, wherein determining the pressure torque comprises:
determining the combustion pressure torque based on a required torque of the engine, a rotation speed of the engine, and a Wide Open Throttle (WOT) combustion pressure torque profile in which a combustion pressure torque at each crank angle of the engine in a state in which a throttle valve of the engine is fully open is preset.

14. The method of claim 13, wherein determining the combustion pressure torque comprises:
determining the combustion pressure torque based on the WOT combustion pressure torque profile, and a transient combustion pressure torque profile obtained by compensating a steady-state combustion pressure torque profile, determined based on the required torque and the rotation speed of the engine, based on a crank angle shift amount depending on ignition timing of the engine.

15. The method of claim 14, wherein the crank angle shift amount is determined based on a first crank lag angle from the ignition timing of the engine to a maximum pressure generation point of the engine and a second crank lag angle from the maximum pressure generation point of the engine to a maximum torque generation point of the engine.

16. The method of claim 15, wherein the first crank lag angle is determined based on the ignition timing, the rotation speed, and the required torque of the engine.

17. The method of claim 15, wherein the second crank lag angle is determined based on the rotation speed and required torque of the engine.

18. The method of claim 15, wherein the crank angle shift amount is determined based on a value obtained by subtracting a value corresponding to the rotation speed of the engine among ignition timings in a preset Wide Open Throttle (WOT) state in which a throttle valve of the engine is fully open from a sum of the first crank lag angle and the second crank lag angle.

19. The method of claim 12, wherein determining the pressure torque comprises determining the motoring pressure torque based on a rotation speed and a required torque of the engine.

20. The method of claim 11, wherein determining the engine torque fluctuations comprises determining the engine torque fluctuations based on a value obtained by subtracting a required torque of the engine from a sum of the inertial torque and the pressure torque.
